(19) United States
(12) Patent Application Publication
(10) Pub. No.: US 2019/0223469 A1
(43) Pub. Date: Jul. 25, 2019

(54) USE OF NITRATE FOR IMPROVING THE REPRODUCTIVE PERFORMANCE OF MONOGASTRIC MAMMALS

(71) Applicant: YARA INTERNATIONAL ASA, Oslo (NO)

(72) Inventors: Christian ANDERSSON, Vejbystrand (SE); Tore FROGNER, Sylling (NO); Leif GÖRANSSON, Kagerrod (SE)

(73) Assignee: YARA INTERNATIONAL ASA, OSLO (NO)

(21) Appl. No.: 16/298,231

(22) Filed: Mar. 11, 2019

Related U.S. Application Data
(62) Division of application No. 15/568,977, filed on Oct. 24, 2017.

(30) Foreign Application Priority Data
May 6, 2015 (NO) 20150560

(51) Int. Cl. A23K 20/20; A23K 20/142; A23K 50/30

(52) U.S. Cl. CPC A23K 20/20; A23K 50/30; A23K 20/142

(57) ABSTRACT

The present invention is related to the field of breeding domestic livestock, in particular to animal nutrition for domestic livestock, more in particular to nutritional supplements and additives for breeding monogastric mammals, most specifically inorganic nitrate compounds for use in a method of improving the (re)productive performance of a female monogastric mammal. The present invention provides, among others, a method of improving the (re)productive performance of a female monogastric mammal, feed supplements and feed compositions comprising inorganic nitrate compounds.

### TECHNICAL FIELD

The present invention is related to the field of breeding domestic livestock, in particular to animal nutrition for domestic livestock, more in particular to nutritional supplements and additives for breeding monogastric mammals, most specifically inorganic nitrate compounds for use in a method of improving the (re)productive performance of a female monogastric mammal. The present invention provides, among others, a method of improving the (re)productive performance of a female monogastric mammal, feed supplements and feed compositions comprising inorganic nitrate compounds.

### BACKGROUND OF THE DISCLOSURE

The (re)productive performance of a female monogastric mammal such as pigs, is a great concern for farmers, for breeding said mammals in the best conditions. Modern monogastric mammals, such as pigs, give birth to many newborns (e.g. on the average 25 to 35 piglets per sow per year, divided over 2.2 to 2.4 litters per sow). Both from an economical and animal welfare point of view, newborn mortality should be minimized. The (re)productive performance might be improved by, for example, by reducing the incidence of foetal birth and stillbirth, thus enlarging the litter size at birth, improving the growth of newborns, elevating the rate of raising newborns, such as by early weaning, increasing the health of the gestating and/or lactating female monogastric mammal and increasing the pregnancy frequency thereof. In domestic mammals, such as pigs, the growth of newborns and infants is affected mainly by the birth weight of the newborn or infant and the lacteal quality and yield of the mammal mother, in addition to the general factors of, for example, temperature and humidity of the animal's environment. In the case of pigs, for example, the mortality rate of piglets with a birth weight of less than 1 kg amounts to 55-100%, the ratio of late foetal mortality, stillbirth and early neonatal mortality at piglets amounts to about 8% each (or 24% per litter), and the overall mortality rate before weaning occurring at 2 to 6 weeks after birth amounts to 15-20% of live born piglets. Such a high mortality rate is caused by the fact that a piglet with a low body weight can hardly maintain its body temperature, has only a limited suckling power and is frequently crushed by its mother or other animals nearby.

Hence, there is the need for improving the (re)productive performance of a female monogastric mammal, in particular for increasing the health of the gestating and/or lactating female monogastric mammal, for increasing the number of live born newborns produced per gestating female and for increasing the weight of newborns, thereby decreasing the risk of mortality and increasing the weaning weight when reaching the weaning stage, for example, for piglets at 2 to 6 weeks after birth. This method is preferably used during the pregnancy period, throughout the suckling period, and up to the weaning of the infants.

### PRIOR ART

According to a classical approach, the (re)productive performance of female monogastric mammals is improved by the addition of antibiotics, in particular antibiotic growth promoters, to the feed of gestating mammals, mammals after farrowing, lactating mammals, and newborns. The term “antibiotic growth promoter” is used to describe any medicine that destroys or inhibits bacteria and is administered at a low, sub-therapeutic dose to newborns. The use of antibiotics for growth promotion has arisen with the intensification of livestock farming. Infectious agents such as Salmonella, Campylobacter, Escherichia coli, Clostridium and Enterococci reduce the yield of newborns and, to control these, the administration of antibiotic growth promoters has been shown to be effective, especially in the mouth and gastro-intestinal tract of the mother and the newborn animal. The use of antibiotics is largely a problem of intensive farming methods and the problems caused by their use are largely those of developed rather than developing countries. The use of any antibiotic is associated with the selection of resistance in pathogenic bacteria and it has been argued that the use of antibiotics imposes a selection pressure for bacteria that are resistant to antibiotics that may be used in clinical or veterinary and/or human practice, thus compromising the continued use of antimicrobial chemotherapy. Hence, there is a need for alternative approaches, treatments and compositions for improving the (re)productive performance of a female monogastric mammal.

EP0710447 B1 (MEIJI CO Ltd, 1996) discloses a method for reducing the incidence of premature piglets which comprises providing a feed to a gestating sow at least two weeks prior to the farrowing, said feed containing saccharides, mainly composed of fructooligosaccharides and then continuing the feeding through the time of farrowing and until weaning.

RU2130255 C1 (1999) discloses a method for increasing the reproductive ability of sows through the integrated use of hormonal (progesterone) and vitamin (Tetravit) preparations into the feed for sows during the gestation period, as well as during the whole sucking period.

EP1408771 A1 (Nutreco Nederland B.V., 2003) discloses a method for increasing the breeding productivity of an animal livestock, in particular a livestock of porcine species, comprising providing a diet to a gestating animal of said livestock, resulting in a daily dosage of 200 to 1300 mg L-arginine per kg bodyweight of said animal. A premix comprising 1 to 50 weight % of L-arginine has been described, which premix is mixed with the final feed in an amount of 0.1 to 20 weight %, based on the total weight of the mixed feed. The effect of L-arginine was related to reducing placental insufficiency, being the main reason for foetal mortality, stillbirth and early neonatal mortality, by improving angiogenesis and thus vascularization of the placenta, by which the development of embryos and foetuses in the uterus is improved.

The abovementioned method was also investigated by Mateo R D, Wu G, Bazer F W, Park J C, Shinzato I, Kim S W. Dietary L-arginine supplementation enhances the reproductive performance of gilts. J Nutr 137, 652-66 (2007) and Mateo R D, Wu G, Moon H K, Carroll J A, Kim S W. Effects of dietary arginine supplementation during gestation and lactation on the performance of lactating primiparous sows and nursing piglets. J Anim Sci 86, 827-35 (2008), where the effect was related to the effect of nitric oxide (NO) on the cardiovascular system. The main working hypothesis disclosed was that dietary supply of arginine to gestating sows will manipulate the arginine-nitric oxide (NO) and polyamine pathways, aiming to enhance placental blood vessel development and/or placental blood flow and thereby improve foetal survival and growth. Positive effects are disclosed on litter size and piglet birth weight and on suckling litter weight gain by adding 1 weight % of L-arginine to the diet.

UA45529 U (2009) discloses a method for increasing the reproductive ability of sows which includes enriching the animal feed with microbially produced β-carotene and biomass of the fungus strain Blakeslea trispora IMB F-10022.

RU2457678 C (2011) discloses a method wherein piglets in utero are fed with humic peat supplement before birth through the placenta of a gestating sow, which diet is enriched with humic peat supplement for three weeks before farrowing in a dose of 0.20 to 0.40 ml/kg body weight, and after farrowing before being transferred to the nursery with sow milk, which diet is enriched with humic peat supplement in the same dose until weaning. The method enables to eliminate the mortality of newborn piglets, to increase the number of viable piglets and to accelerate the increase in weight, as well as to enhance the effectiveness of preventive therapy of iron deficiency anemia of piglets.

The prior art methods seem to target either the microbial status of the female mammal and newborn, or the placental blood vessel development and/or placental blood flow of the female mammal.

### SUMMARY OF THE INVENTION

Surprisingly, the inventors have now found that by adding a small but effective amount of inorganic nitrate to the feed of a gestating female monogastric mammal and/or to the feed of a lactating mammal, the weight fluctuation of the female monogastric mammal could be reduced during lactation (less weight loss), such that the female monogastric mammal has even a higher weight and is in a better health state at the end of the weaning period.

It should be clear for the skilled person that the method according to the invention is directed to the female mammal, either or both of gestating, and having given birth to newborns and lactating said newborns, thereby feeding the newborns. The effect on the newborns (such as litter size at birth, weight of the newborns and weaning weight) is not derived from animal feed, other than the feed obtained from the mother milk, fed to the newborns.

Nitrate is usually associated with nitrite poisoning, e.g. in cattle grazing crops (P. J. O'Hara and A. J. Fraser, Nitrate poisoning in cattle grazing crops, New Zealand Veterinary Journal, 23 (4), 1975). Nitrates (NO⁻³) themselves are not very toxic, contrary to nitrites (NO⁻²) to which they are converted (reduced). Acutely, nitrite is approximately ten-fold more toxic than nitrate.

Because of its potential for toxicity at excessive levels of intake, the Directive (EC) No 2002/32/EC on undesirable substances in animal feed established maximum limits for sodium nitrite in complete animal feeds excluding feeds, intended for pets, except birds and aquarium fish, and fish meal, of 15 and 60 mg/kg, respectively (corresponding to 10 and 40 mg/kg for the nitrite ion). Nitrite in drinking water is regulated in Europe, with a maximum level of 0.5 mg/L. The Acceptable Daily Intake (ADI) for nitrite of 0 to 0.07 mg/kg body weight per day has been endorsed by the Panel on Contaminants in the Food Chain (CONTAM Panel) of the European Food Safety Authority during the recent risk benefit assessment of nitrate in vegetables (The EFSA Journal 1017, 1-47 (2009)).

In ruminant animals such as cattle, sheep and goats, the conversion of nitrate to nitrite is carried out by rumen bacteria. In the rumen, the reduction of nitrate to nitrite occurs rapidly whereas the conversion into ammonia (the detoxification of nitrite) is a slower process.

Ruminants are not very sensitive to moderate levels of nitrate, but care must be taken with higher doses of nitrate. Initial development of poisoning occurs when the nitrite level in the rumen exceeds the microbe's capacity to convert nitrite to ammonia. Nitrite is subsequently absorbed across the rumen wall into the bloodstream where it combines with haemoglobin in the red blood cells and forms methaemoglobin, reducing the capacity of the red blood cells to carry oxygen to body tissue.

Reports of adverse effects after excessive nitrite exposure in livestock exist, and pigs and ruminants, as major food producing animals, are particularly susceptible: this is because of relatively low nitrite reductase activity and high levels of rumen conversion of exogenous nitrate to nitrite, respectively. Hence, the presence of high nitrate and nitrite concentrations in food has been reported to be associated with increased risk of intestinal cancer and methaemoglobinemia which decrease the blood transport capacity of oxygen. On the other hand, recent findings indicate no significant link between nitrate and cancer. In addition, nitrite accumulation in the rumen is known to reduce microbial activity in the rumen, which, inter alia, may reduce feed intake by the animal.

In contrast monogastric mammals like horses and pigs, do not have rumen bacteria for conversion of nitrates to nitrites, which occurs with monogastric mammals in the intestine, i.e. closer to the end of the digestive tract. In this situation, there is a less opportunity for the nitrites to be absorbed. This being said, it should be noted that pigs are amongst the most sensitive species due to their low methaemoglobin reductase activities in red blood cells and should not be exposed to large amounts of nitrate (and nitrite).

The inventors have recognized this difference between ruminants and monogastric mammals and have developed a method of improving the (re)productive performance of a female monogastric mammal, said method comprising administering to said female monogastric mammal an effective amount of a inorganic nitrate compound.

Reports on the physiological role of dietary nitrate for mammals are scarce and give a diverse and often conflicting view on the subject matter.

Dietary nitrate and nitrite are transformed in the body in several ways, by the action of bacterial nitrate reductases on the tongue and by mammalian enzymes that have nitrate reductase activity in tissues, and mammalian enzymes that have nitrite reductase activity. Contrary to its reputation as a poison, nitric oxide and or other metabolic products of nitrates widen the blood vessels, decrease blood pressure and support cardiovascular function. This role of nitrite and a protective action against low oxygen supply in different tissues paints a different picture and has led to a renewed interest in the physiological and pharmacological properties of nitrite and nitrate (Butler A R, Feelisch M. Therapeutic Uses of Inorganic nitrite and nitrate from the past to the future. Circulation 117, 2151-2159 (2008)). Many vegetables and fruits contain high levels of nitrate and it has been hypothesised that the blood pressure-lowering effect of plant foods may be effects of their nitrate content (Hord N D, Tang Y, Bryan N S. Food sources of nitrates and nitrites: the physiologic context for potential health benefits. Am J Clin Nutr 90:1-10 (2009)). Interestingly, both potassium nitrite, in 1880, and potassium nitrate, in 8th century China, was known to mediate hypotensive and antianginal actions (protection against angina pectoris).

In vitro acidified nitrite has been demonstrated to have a substantial antimicrobial effect on human pathogens (Dykhuizen R S, Frazer R, Duncun C, Smith C, Golden M, Benjamin N, Leifert C. Antimicrobial effect of acidified nitrite on gut pathogens: Importance of dietary nitrate in host defense. Antimicrobial agents and chemotherapy 40, 1422-1425 (1996)).

Challenges with high dietary nitrate in pigs increased nitrite in saliva, which decreased the microbial diversity in the mouth of the pigs (Trevisi P, Casini L, Nisi I, Messori S, Bosi P. Effect of high oral doses of nitrate on salivary recirculation of nitrates and nitrites and on bacterial diversity in the saliva of young pigs. J Anim Phys and Anim Nutr 95, 206-213 (2011)).

Increased nitrite in saliva was also found in another piglet study with high level of nitrate in the diet (Posi P, Casini L, Tittarelli C, Minieri L, De Filippi S, Trevisi R, Clavenzani R, Mazzoni M. Effect of dietary addition of nitrate on growth, salivary and gastric function, immune response, and excretion of Salmonella enterica serovar typhimurium, in weaning pigs challenged with this microbe strain. It J Anim Sci 6 Suppl 1, 266-268 (2007). Although these piglets were orally challenged with salmonella, no decrease in number of salmonella in the gut was found. Interestingly, IgA in serum tended to increase in pigs fed the high nitrate diet and the productive performance was not adversely affected.

The finding that high dietary nitrate does not affect the colonisation of salmonella in the stomach and jejunum of newly weaned piglets was also demonstrated in another study (Modesto M, D'Aimmo M R, Stefanini I, Mazzoni M, Bosi P, Biavati B. Antimicrobial effect of dietary nitrate in weaning piglets challenged or not with Salmonella enterica serovar typhimurium. Cultivating the Future Based on Science: 2nd Conference of the International Society of Organic Agriculture Research ISOFAR, Modena, Italy, June 18-20, 2, 146-149 (2008)), which on the other hand reported a reduction of lactic acid bacteria in the mentioned segments. This reference points out that ulceration was not affected. In a later report from the same research team (Modestoa M, Stefaninia I, D'Aimmoa M R, Nissena L, Tabanellia D, Mazzonib M, Bosib P, Strozzic G P, Biavatia B. Strategies to augment non-immune system based defence mechanisms against gastrointestinal diseases in pigs. Wageningen J Life Sci 58, 149-156 (2011)), a maximum level of nitrate, allowed by the EU for feedstuffs, was combined with one pro- and one prebiotic substance in a diet for weaned piglets. The experimental diet did not affect the content of lactic acid bacteria, clostridia and yeasts in stomach or jejunum, nor did it affect E. coli contents. The use of nitrate in combination with a probiotic improved however weight gain, feed efficiency and health status of the weaned piglets.

In a Danish study (M. T Sorensen, B. B Jensen, H. D Poulsen Nitrate and pig manure in drinking water to early weaned piglets and growing pigs Livestock Production Science 39(2) 223-227 (1994)) inclusion of nitrate in the water for weaned piglets significantly reduced the number of coliform bacteria in the whole gastrointestinal tract and enhanced the level of lactic acid and ammonia in the stomach and first segments of the small intestine. Feed conversion and weight gain were significantly improved for piglets with nitrate added in the drinking water.

No references were found where nitrate was fed to gestating or lactating female monogastric mammals.

Without being bound by theory, it is theorized that the method according to the invention has a double positive effect on the (re)productive performance of the female mammal. On the one hand, it decreases the number of potentially endotoxin-producing bacteria in the gut of the gestating and/or lactating mammal, thereby lowering the risk of PDS (Postparturient Dysgalactia Syndrome) and, on the other hand, it reduces the weight fluctuation of the female monogastric mammal, in particular the weight loss during lactation (less weight loss), such that the female monogastric mammal has even a higher weight and is in a better health state at the end of the weaning period, while no statistically significant negative effects on the litter size and weight could be determined.

The use of nitrate in animal feed for ruminants, such as cattle, has been disclosed in WO2011/010921 A2 (Provimi, 2011) which discloses a non-therapeutic method of reducing gastro-intestinal methane production in a ruminant, said method comprising administering to said ruminant an effective amount of a combination of a nitrate compound and a sulphate compound.

Patra, A. K. and Yu, Z. disclose combinations of nitrate, saponin and sulphate to additively reduce methane production by rumen cultures in vitro while not adversely affecting feed digestion, fermentation or microbial communities, Bioresource Technology 155, pp. 129-135 (2014).

The use of an inorganic nitrate compound for improving the (re)productive performance of a female monogastric mammal has not been disclosed nor suggested in the prior art and is therefore deemed novel and inventive.

### BRIEF DESCRIPTION OF THE DRAWING

FIG. 1 is an overview of the measurements that were performed and recorded during Experiment 2.

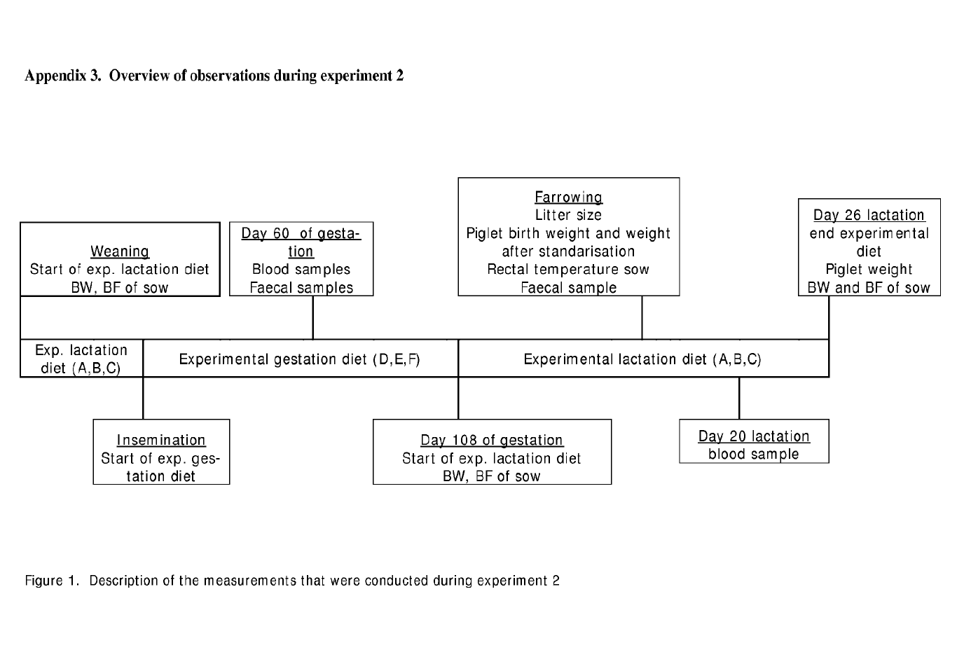

### DETAILED DESCRIPTION OF THE INVENTION

In this description and in the attached claims, the verb “to comprise” and its conjugations is used in its non-limiting sense to mean that items following the word are included, but items not specifically mentioned are not excluded. In addition, reference to an element by the indefinite article “a” or “an” does not exclude the possibility that more than one of the element is present, unless the context clearly requires that there be one and only one of the elements. The indefinite article “a” or “an” thus usually means “at least one”.

Method for Improving the (Re)Productive Performance

According to the invention, a method for improving the (re)productive performance of a female monogastric mammal is provided, said method comprising providing a diet to said female monogastric mammal, resulting in a daily dosage of nitrate, provided by an inorganic nitrate compound, per kg bodyweight of said mammal.

Within the context of the present invention, it is clear that the mammal according to the invention is always a female mammal, gestating or lactating after farrowing. Hence, when the wording “mammal” is used, it is implicitly understood that a female mammal is meant.

Within the context of the present invention, when the wording “(re)productive performance” is used, it is defined as the ability of the female monogastric mammal to give birth to newborns (reproductive performance) as well as the ability of the female monogastric mammal to raise said newborns (productive performance) up to weaning, as well as the ability of the female monogastric mammal to maintain a good health. The present inventions aims to improve the (re)productive performance, such as by reducing the incidence of foetal birth and stillbirth, thus enlarging the litter size at birth, increasing the birth weight of the newborn, reducing the incidence of neonatal mortality, improving the growth of newborns, increasing the health of the gestating and/or lactating female monogastric mammal, increasing the pregnancy frequency thereof, increasing the lacteal quality and yield of the mammal mother, and elevating the rate of raising newborns.

Within the context of the present invention, a monogastric mammal is defined as a mammal having a simple single-chambered stomach, in comparison with a ruminant mammal, such as a cow, goat, or sheep, which has a four-chambered complex stomach. Examples of monogastric mammals comprise omnivores such as, for example, monkeys, rats, dogs and pigs, and carnivores such as, for example, cats, and herbivores such as, for example, horses and rabbits. Herbivores with monogastric digestion can digest cellulose in their diets by way of symbiotic gut bacteria. However, their ability to extract energy from cellulose digestion is less efficient than in ruminants. Preferably, the monogastric mammal is a porcine species, in particular a swine or pig, more in particular a piglet, a gilt or a sow. The term “monogastric mammal” is equivalent with the term “non-ruminant”.

Within the context of the present invention, a monogastric mammal does not comprise a human. A human mammal is explicitly excluded from the scope of the present invention.

Within the context of the present invention, “improving” the (re)productive performance encompasses reducing the incidence of foetal birth and stillbirth, enlarging the litter size at birth, increasing the birth weight of the newborn, reducing the incidence of neonatal mortality, improving the growth of newborns, increasing the lacteal quality and yield of the mammal mother, as well as the ability of the female monogastric mammal to maintain a good health and elevating the rate of raising newborns.

According to one embodiment, a method is claimed for improving the (re)productive performance of a female monogastric mammal, wherein a daily dosage of nitrate, provided by an inorganic nitrate compound, is administered to a gestating monogastric mammal or to a lactating monogastric mammal.

A preferred embodiment of the invention provides a method as defined above, wherein the inorganic nitrate compound is administered to the monogastric mammal in an amount providing a total average daily dosage of nitrate in excess of 1 mg/kg body weight. In a preferred embodiment said total average daily dosage of nitrate in the present method is within the range of 1 to 320 mg/kg body weight. Within the context of this application, when referred to nitrate, there is referred to the NO₃⁻² ion. For example, anhydrous calcium nitrate has the chemical form Ca(NO₃)₂, is a nitrate salt and comprises about 76% of nitrate.

The total average daily dosages defined herein as the amount per kg body weight concern the average amount of the respective inorganic nitrate compound during a given period of treatment, e.g. during a week or a month of treatment. The compounds may thus be administered every day, every other day, every other two days, etc., without departing from the scope of the invention. Preferably though, the method comprises daily administration of the inorganic nitrate compound in the prescribed dosages. Even more preferably, the inorganic nitrate compound is administered during feeding of the animal each time the mammal is fed, in amounts yielding the above daily dosages. Most preferably, the inorganic nitrate compound is administered daily during feeding of the animal each time the mammal is fed, in amounts yielding the above daily dosages.

The inorganic nitrate compound is a physiologically acceptable or tolerated nitrate compound, preferably of feed quality. In accordance with the invention, the nitrate ion needs to be readily available for reduction to nitrite and the nitrate compound should have sufficient solubility in water. Hence, in accordance with this invention, the inorganic nitrate compound is preferably an ionic nitrate compound, most preferably an inorganic nitrate salt, most preferably selected from the group of sodium nitrate, potassium nitrate, calcium nitrate, ammonium nitrate, or any combination, mixture or double salt thereof, all of which are readily soluble in water at standard temperature and pressure. Furthermore, from a health and safety perspective, it is typically preferred to use complex inorganic nitrate salts, such as calcium ammonium nitrate, most preferably the compound, represented by the formula 5Ca(NO₃)₂—NH₄NO₃.10H₂O, which is commercially available from Yara International ASA, Norway as YaraLiva® and which is also available in feed quality.

According to an embodiment, the nitrate may also be delivered by nitric acid, for example as an aqueous solution of nitric acid.

The inorganic nitrate compound may be available in the form of a powder, a compacted powder, a crystal, a prill, granule, a liquid, a gel, a solution, a liquid, or a flake.

According to a preferred embodiment, the method according to the invention is preferably carried out by administering said daily dosage of said nitrate to a gestating monogastric mammal in one of the so-called critical periods. It has been described that normally, during gestation, mammals such as pigs, go through at least three of such critical phases, which are characterized by a dramatic drop in embryo or foetus count. For pigs, the initial (i.e. at day 0 of gestation, directly after fertilization) number of viable embryos is about 17. After about 35-40 days of gestation, this number drops considerably. This period corresponds to the period of embryo implantation (critical period I) and is preceded by a period of rapid placenta growth, which takes place at about days 14 to 30 of gestation. In the period which follows the embryo implantation, the foetal count is more or less stable. Then, at about days 55 to 75 of gestation, a considerably drop in number of viable foetuses is again observed. This period corresponds to the period wherein the placenta reaches its maximum size (critical period II). After this period, the foetal count is stable again. Finally, at about days 105 to 115 of gestation, which for pigs corresponds to the so-called perinatal period (critical period II), a drop in number of viable foetuses is again observed, which is believed to be the result of uterine crowding.

In a preferred embodiment of the method of the invention is carried out in one or more of the above-mentioned critical periods. Thus, it is preferred to carry out the method of the invention during the period of embryo implantation in the gestating mammal. It is also preferred to carry out the method of the invention during the period of placenta growth, which coincides with embryo implantation. Finally, It is also preferred to carry out the method of the invention during the perinatal period.

For pigs, this means that, for a gestating monogastric sow, the method according to the invention is carried out at least during days 14 to 30 of gestation, days 55 to 75 of gestation or days 105 to 115 of gestation.

Of course, the method according to the invention is not limited to the above cited periods and may also be practiced outside the periods mentioned.

Most preferably, said daily dosage of said nitrate is essentially uninterrupted administered to a monogastric female mammal, in particular a sow, both during gestation and lactation.

The method of the invention can be carried out independently or as an add-on method to another method, either sequentially or in parallel, in particular another method for improving the (re)productive performance of a female monogastric mammal. Preferably, the method of the invention is carried out as an add-on method to the method as described in EP 1408771 A1, wherein an effective amount, in particular a daily dosage of 200 to 1300 mg L-arginine per kg bodyweight of said animal is administered to said animal.

As will be clear from the above, the present method comprises the oral administration of the inorganic nitrate compound and, optionally, any other additive combined therewith. Preferably, the treatment comprises oral administration of a compounded animal feed composition and/or an animal feed supplement as defined herein below, even though other liquid, solid or semi-solid orally ingestible compositions may be used without departing from the scope of the invention, as will be understood by those skilled in the art.

According to one aspect, the present method of treatment concerns a non-therapeutic method of treatment, i.e. the method does not improve the health of a monogastric mammal suffering from a particular condition, it does not treat a particular disease or malfunction, nor does it to any extent improve the health of a monogastric mammal in need of said treatment in any other way, i.e. as compared to a monogastric mammal not receiving the present method of treatment. The advantages of the present method are limited to economical and animal welfare aspects, i.e. minimizing newborn mortality and optimizing breeding domestic livestock.

According to another aspect, the invention concerns a therapeutic method of treatment of inorganic nitrate-supplemented monogastric gestating or lactating mammals. According to yet another aspect, the invention concerns use of inorganic nitrate and inorganic nitrate-supplemented feed in therapeutic and/or prophylactic treatment of monogastric gestating or lactating mammals. As demonstrated, it is shown that nitrate supplementation of said mammal could decrease the number of potentially endotoxin-producing bacteria in the gut of said mammal, thereby lowering the risk of PDS (Post-parturient Dysgalactia Syndrome). It is also hypothesised that inorganic nitrate and inorganic nitrate-supplemented feed could improve the nutrient supply of the foetus in the gestating mammal by improving angiogenesis and/or vascularization of the placenta, by which the development of embryos and foetuses in the uterus is improved.

The inorganic nitrate compound, being a feed additive, can be administered to a female monogastric mammal in several forms, some of which are discussed below. According to one embodiment, the feed additive can be admixed with other feed additives into a premix, further optionally comprising vitamins, trace elements, enzymes and other additives. Such premix is suitable for being added to a feed supplement or a complete compounded animal feed. According to another embodiment, the feed additive can also be directly mixed with the complete feed or with the feed supplement. For example, the feed additive can be admixed with a feed supplement in the form of a top dress, a mineral feed, a licking block or other forms of supplemental feeds.

Animal Feed Supplement

As used, herein the term “animal feed supplement” refers to a premix or a feed supplement, as defined above.

According to a further aspect, the invention is concerned with an animal feed supplement comprising 10 to 100 weight % of an inorganic nitrate compound for use in the treatment of a gestating and/or lactating monogastric mammal for improving (re)productive performance, as well as for use in the treatment of a lactating monogastric mammal for lowering the risk of PDS (Post-parturient Dysgalactia Syndrome).

Typically, the animal feed supplement of the present invention is in the form of a powder or compacted, -granulated solid or liquid. In practice, the animal feed supplement may typically be fed to the livestock by adding it directly to the ration, e.g. as a so-called top-dress, or it may be used in the preparation or manufacture of products such as compounded animal feeds or lick blocks, which will be described in more detail hereafter. The invention is not particularly limited in this respect. An animal feed supplement, according to the invention is typically fed to an animal in an amount ranging from 16 to 2500 g/animal/day.

The present animal feed supplement comprises a nitrate compound, typically a physiologically acceptable or tolerated nitrate compound, preferably of feed quality. In accordance with the invention, the nitrate ion needs to be readily available for reduction to nitrite and the nitrate compound should have sufficient solubility in water. Hence, in accordance with this invention, the inorganic nitrate compound is preferably an ionic nitrate compound, most preferably an inorganic nitrate salt, most preferably selected from the group of sodium nitrate, potassium nitrate, calcium nitrate, ammonium nitrate, or any combination, mixture or double salt thereof, all of which are readily soluble in water at standard temperature and pressure. Furthermore, from a health and safety perspective, it is typically preferred to use complex inorganic nitrate salts, most preferably the compound, represented by the formula 5Ca(NO₃)₂—NH₄NO₃-10H₂O, which is commercially available from Yara International ASA, Norway and which is available in feed quality.

The inorganic nitrate compound may be available in the form of a powder, a compacted powder, a crystal, a prill, granule, a liquid, a gel, or a flake.

According to a preferred embodiment of the invention, the animal feed supplement comprises the inorganic nitrate compound in an amount ranging from 10 to 100 weight %, preferably said amount is in excess of 10, 20, 30, 40, 50, 60, 70, 80, 90, 95, 97 or 99 weight %, on a dry weight basis.

The inorganic nitrate compound in the animal feed supplement of the invention typically provides a total amount of nitrate in excess of 0.2 g/kg, on a dry weight basis. In practice, said amount typically is below 750 g/kg.

All the amounts and/or dosages of ‘nitrate’ as used herein, unless indicated otherwise, refer to the weight of nitrate comprised in or provided by the nitrate compounds, relative to total dry weight of the composition, as will be understood by the skilled person. It is within the skills of the skilled person to determine exactly the ideal amounts of the components to be included in the supplement and the amounts of the supplement to be used in the preparation of the ration or compounded animal feed, etc., taking into account the specific type of mammal and the circumstances under which it is held. Preferred dosages of each of the components are given below.

The animal feed supplements of the present invention may comprise any further ingredient without departing from the scope of the invention. It may typically comprise well-known excipients that are necessary to prepare the desired product form and it may comprise further additives that are aimed at improving the quality of the feed and/or at improving the performance of the animal consuming the supplement. Suitable examples of such excipients include carriers or fillers, such as lactose, sucrose, mannitol, starch, crystalline cellulose, sodium hydrogen carbonate, sodium chloride and the like, and binders such as gum Arabic, gum tragacanth, sodium alginate, starch, PVP and cellulose derivatives, etc. Examples of feed additives that are known to those skilled person include vitamins, amino acids and trace elements, digestibility enhancers and gut flora stabilizers and the like.

In a preferred embodiment, the animal feed supplement additionally comprises an effective amount of L-arginine, as described in EP1408771 A1, such that a daily dosage of at least 200 mg L-arginine per kg bodyweight of said mammal, preferably of 200 to 1300 mg L-arginine per kg bodyweight of said mamma is administered to said mammal. Preferably, said animal feed contains 1 to 50 weight %, more preferably 1.25 to 10 weight % of L-arginine.

In a special embodiment, the invention provides a licking stone (also called licking block) comprising the supplement of the invention. As is known to those skilled in the art, such licking stones are particularly convenient for feeding mineral supplements (as well as proteins and carbohydrates), for example to horses grazing either or both natural and cultivated pastures. Such licking stones in accordance with the present invention typically comprise, in addition to the inorganic nitrate compound, various types of binders, e.g. cements, gypsum, lime, calcium phosphate, carbonate, and/or gelatine, and optionally further additives such as vitamins, trace elements, mineral salts, sensory additives, etc.

Compounded Animal Feed

A further aspect of the invention concerns a product such as a compounded animal feed the animal feed supplement as defined herein before.

According to one aspect of the invention, a compounded animal feed composition is provided comprising an inorganic nitrate compound, providing a total amount of nitrate in excess of 0.1 g/kg, on a dry weight basis.

The term ‘compounded animal feed composition’ as used herein, means a composition which is suitable for use as an animal feed and which is blended from various natural or non-natural base or raw materials and/or additives. Hence, in particular, the term ‘compounded’ is used herein to distinguish the animal feed composition according to the invention from any naturally occurring raw material. These blends or compounded animal feed compositions are formulated according to the specific requirements of the target animal. The main ingredients used in commercially prepared compounded animal feed compositions typically include wheat bran, rice bran, corn meal, cereal grains, such as barley, wheat, rye and oat, soybean meal, alfalfa meal, wheat powder and the like. A commercial compound feed composition will typically comprise no less than 10 weight % of crude protein and no less than 75 weight % of dry matter, although the invention is not particularly limited in this respect. Liquid, solid as well as semi-solid compounded animal feed compositions are encompassed within the scope of the present invention, solid and semi-solid forms being particularly preferred. These compositions are typically manufactured as meal type, pellets, crumbles, muesli, extruded feed and expanded feed. In practice, livestock may typically be fed a combination of compounded animal feed compositions, such as that of the present invention, and silage or hay or the like. Typically, a compounded animal feed composition is fed in an amount within the range of 0.3 to 12 kg/animal/day, depending on the animal species. It is within the skills of the skilled person to determine proper amounts of these components to be included in the compounded animal feed composition, taking into account the animal species and the circumstances under which it is held.

The nitrate compound in the compounded animal feed composition of the invention typically provides a total amount of nitrate in excess of 0.1 g/kg, on a dry weight basis. The compounded animal feed composition of the invention may comprise any further feed additive typically used in the art. As is known by those skilled in the art, the term ‘feed additive’ in this context refers to products, used in animal nutrition for purposes of improving the quality of feed and the quality of food from animal origin, or to improve the animals' performance, e.g. providing enhanced digestibility of the feed materials. Non-limiting examples include technological additives such as preservatives, antioxidants, emulsifiers, stabilising agents, acidity regulators and silage additives; sensory additives, especially flavours and colorants; nutritional additives, such as vitamins, amino acids and trace elements; and zootechnical additives, such as digestibility enhancers and gut flora stabilizers.

As will be clear to those skilled in the art, the present compounded animal feed composition can comprise any further ingredient or additive, without departing from the scope of the invention.

Inorganic Nitrate to Promote a Healthy Gut Flora.

The microflora in the faeces of the sows is known to be responsible for the instauration of a healthy microflora in the new born piglets that are born with a sterile gastrointestinal tract. It has been proposed that a balanced microflora in suckling piglets reduces diarrhoea incidence during the suckling period but also after weaning. A balanced microflora will thus effect the sows ability to raise the piglets.

It has been demonstrated that the bacteria counts, such as counts of Clostridia perfringens, in faeces is lower for the sows supplemented with calcium nitrate double salt in both the gestation period and the lactation period. Thus, feed supplemented with inorganic nitrate, such as calcium nitrate double salt, has the ability to decreases the number of potentially endotoxin-producing bacteria in the gut of the gestating or lactating mammal, thereby lowering the risk of PDS (Post-parturient Dysgalactia Syndrome), thus affecting the sows productive performance, e.g. the ability to raise the piglets.

Accordingly, the invention provides inorganic nitrate, selected from the group of sodium nitrate, potassium nitrate, calcium nitrate, ammonium nitrate, or any combination thereof, most preferably the compound represented by the formula 5Ca(NO₃)₂.NH₄NO₃-10H₂O, for use to decreases the number of potentially endotoxin-producing bacteria in the gut, and/or promoting a healthy gut flora and/or lowering the risk of PDS (Postparturient Dysgalactia Syndrome). In one embodiment, the invention is directed to an animal feed supplemented with inorganic nitrate, selected from the group of sodium nitrate, potassium nitrate, calcium nitrate, ammonium nitrate, or any combination thereof, most preferably the compound represented by the formula 5Ca(NO₃)₂.NH₄NO₃-10H₂O, for prophylactic and/or therapeutic treatment of PDS (Post-parturient Dysgalactic Syndrome).

According to another embodiment the invention is directed to an animal feed supplement comprising 10 to 100 weight % of an inorganic nitrate compound, or inorganic nitrate, selected from the group of sodium nitrate, potassium nitrate, calcium nitrate, ammonium nitrate, or any combination thereof, most preferably the compound represented by the formula 5Ca(NO₃)₂.NH₄NO₃-10H₂O, for use as an antibiotic growth promotor.

The term “antibiotic growth promoter” is used to describe any medicine that destroys or inhibits bacteria. Antibiotic growth promotors may be administrated as a daily dose as a feed supplement to gestating mammals, mammals after farrowing and lactating mammals. It may also be administered at a low, sub-therapeutic dose to newborns.

It has been demonstrated that the invention has a double positive effect on the (re)productive performance of the female mammal. On the one hand, it decreases the number of potentially endotoxin-producing bacteria in the gut of the gestating or lactating mammal, thereby lowering the risk of PDS (Post-parturient Dysgalactia Syndrome) and, on the other hand, it reduces the weight fluctuation of the female monogastric mammal during lactation (less weight loss), such that the female monogastric mammal has even a higher weight and is in a better health state at the end of the weaning period. Even though a lesser weight gain was observed during the gestation periode, no statistically significant negative effects on the litter size and weight could be determined.

However, the results demonstrate a significant lower body weight loss for the sows fed the calcium nitrate double salt (P=0.043) compared to the control diet, which will have a positive effect on the reproductive performance of the sows in the next cycle.

Accordingly, the invention provides inorganic nitrate, selected from the group of sodium nitrate, potassium nitrate, calcium nitrate, ammonium nitrate, or any combination thereof, most preferably the compound represented by the formula 5Ca(NO₃)₂.NH₄NO₃-10H₂O, for improving the reproductive performance of a female monogastric mammal, such as a sow. In one embodiment of the invention the inorganic nitrate, selected from the group as described, is administrated to gestating and/or lactating monogastric mammals. In one particular embodiment the inorganic nitrate is administrated in a daily dosage of nitrate in excess of 1 mg/kg body weight, preferably within the range of 1 to 320 mg/kg body weight, at least during days 14 to 30 of gestation, days 55 to 75 of gestation or days 105 to 115 of gestation. In another embodiment the daily dosage is given both during gestation and lactation.

According to a specific embodiment, the invention is concerned with a feed, suitable for a female monogastric mammal, in particular a sow, in lactation and/or gestation phase, comprising:
50-200 g/kg, preferably 100-150 g/kg of crude protein,
10-100 g/kg, preferable 10-50 g/kg of crude fat,
25-200 g/kg, preferably 50-100 g/kg of crude fiber,
150-600 g/kg, preferably 200-400 g/kg of starch,
25-200 g/kg, preferably 50-100 g/kg of sugar, and
0.1-5 weight %, preferably 0.2-2 weight % of calcium ammonium nitrate, most preferably the compound, represented by the formula 5Ca(NO₃)₂—NH₄NO₃.10H₂O.

According to another embodiment, said feed, suitable for a female monogastric mammal, in particular a sow, in lactation and/or gestation phase, comprises in addition 1.25-10 weight % of arginine.

While a description was made with particular reference to the specific embodiments, it will be understood that numerous modifications thereto will appear to those skilled in the art. The scope of the claims should not be limited by specific embodiments provided in the present disclosure, but should be given the broadest interpretation consistent with the disclosure as a whole.

### EXPERIMENTAL

### Experiment 1: Effect of Dietary Treatment on the Health of a Sow

The first experiment consisted of 3 treatments formulated to obtain different levels of calcium nitrate double salt; 0.31, 0.63, 1.25% calcium nitrate double salt) with 5 sows per treatment. The sows were fed the experimental diets during the last 2 weeks of lactation. The composition of the experimental diets for experiment 1 can be found in Appendix 1.

Blood samples to determine methemoglobin levels were taken at start of the feeding period (as a control), after 1 week and end of the feeding period and 1 week after finishing the feeding period (n=4 blood samples per sow). Furthermore, feed intake was registered daily.

In total, 48 sows successfully finished the experiment and were used for the analysis. With regard to the negative effect of the supplementation of calcium nitrate double salt, the results showed that the methaemoglobin/haemoglobin ratios were only slightly increased at day 7 of the experiment but recovered before day 14 of the experiment.

Results

In experiment 1 the effect of dietary nitrate on blood haemoglobin and methaemoglobin and clinical signs of nitrate toxicity were analysed in 15 sows. The experimental diets were analysed on nitrate level to confirm the inclusion rate of the calcium nitrate double salt (Table 1). Analysed nitrate levels were slightly lower than the intended level. However, the deviation was within range to analyse the effect of high levels of dietary nitrate supplementation on the methaemoglobin levels in the blood of the sows.

TABLE 1
Intended and analysed nitrate levels in the experimental diets

| | T1 | | T2 | | T3 | |
|---|---|---|---|---|---|---|
| | 0.31% Calcium nitrate | | 0.63% Calcium nitrate | | 1.25% Calcium nitrate | |
| | double salt | | double salt | | double salt | |
| | Int | Ana | Int | Ana | Int | Ana |
| Nitrate (μg/g) | 2000 | 1700 | 4000 | 3500 | 8000 | 7000 |

No effect of dietary treatment on methemoglobine/hemoglobine was found (Table 2). The levels of methaemoglobin were slightly increased at day 7 for all treatments, however, this increase was not observed at day 14 of the experiment. Furthermore, no clinical signs of nitrate toxicity, like increased respiratory rate, weakness and muscular tremors that indicate a high methaemoglobin level, were observed. Since no significant increase of dietary nitrate on methaemoglobin was found during the period the experimental diets were supplied, it was decided that there was no need for the last blood sampling (7 days after weaning) which was meant to monitor the recovery of the sows.

TABLE 2
Effect of increasing nitrate levels on blood parameters (haemoglobin
(Hb), methaemoglobin (Met Hb) and ratio methaemoglobin/haemoglobin)

| | Day 0 | | | Day 7 | | | Day 14 | | |
|---|---|---|---|---|---|---|---|---|---|
| | | Met | Met | | Met | Met | | Met | Met |
| | Hb | Hb | Hb | Hb | Hb | Hb | Hb | Hb | Hb |
| Treatment | g/dL | g/dL | % | g/dL | g/dL | % | g/dL | g/dL | % |
| 0.31% calcium nitrate | 16.93 | 0.33 | 1.85 | 14.30 | 0.66 | 4.99 | 10.94 | 0.18 | 1.68 |
| double salt | | | | | | | | | |
| 0.63% calcium nitrate | 15.99 | 0.27 | 1.74 | 14.19 | 0.51 | 3.52 | 9.69 | 0.16 | 1.46 |
| double salt | | | | | | | | | |
| 1.25% calcium nitrate | 15.26 | 0.23 | 1.58 | 12.01 | 0.78 | 6.35 | 10.19 | 0.08 | 0.75 |
| double salt | | | | | | | | | |

### Experiment 2: Effect of Dietary Treatment on the (Re)Productive Performance of a Sow

1. Experimental Design

In the second experiment sows were followed during one production cycle (from weaning to weaning). Sixty-three multiparous sows were divided into 3 treatment groups; 1) control, 2) same basal diet as control with supplementation of 0.31% calcium nitrate double salt and 3) same basal diet as control with the supplementation of 0.15% L-arginine to the diet. The level of L-arginine was included to provide the same amount of nitrogen as 0.31% calcium nitrate double salt. An overview of the treatments is given in Table 3. The composition of the experimental diets for experiment 2 can be found in Appendix 2.

TABLE 3
Description of the control and the test
diet used during the experimental period

| | Treatment sows | | | | |
|---|---|---|---|---|---|
| | (WOI¹, gestation | | Diet code | | |
| | and lactation) | Inclusion rate | WOI | Gest. | Lact. |
| 1 | Control | — | A | D | A |
| 2 | Nitrate | 0.31% Calcium nitrate | B | E | B |
| | | double salt | | | |
| 3 | Arginine | 0.15% L-Arginine | C | F | C |

¹Weaning to oestrus interval

2. Diet Composition and Manufacturing

The experimental diets were formulated to meet the requirements for all essential nutrients for sows and piglets according to SFR recommendations. The composition of the experimental diets can be found in Appendix 2. Diets were manufactured by ABZ-Diervoeding in Leusden. This facility is specialised in producing experimental diets with high accuracy. The diets were prepared by double mixing. First a basal diet, sufficient for all treatments was prepared. The basal diet was then split into three portions and the test material was added to create the other two experimental treatments. The diets were pelleted at a maximum processing temperature of 80° C. The diet were produced in 3 batches of gestation diet and 2 batches of lactation diet. After production, all diets were transported to the experimental facilities of Schothorst Feed Research (The Netherlands).

3. Chemical Analysis of the Diets

Samples from each pelleted diet were taken. These samples were split into three portions for analysis by Schothorst Feed Research, analysis by YARA AB and for storage. All diets were analysed for moisture, crude protein (CP), crude fat (EE), crude fibre (CF) and starch by Schothorst Feed Research in order to verify dietary nutrient composition. YARA AB analysed the diets on nitrate content to confirm the inclusion rate of the product. Representative samples of all diets were stored at −20° C. and will be kept for 5 years at Schothorst Feed Research.

4. Animals and Housing

In total 63 sows (parity 2 to 8) were used in the 2^{nd} experiment; 2 rounds with 29 sows in round 1 and 34 sows in round 2. The experiment was conducted with sows in good health and normal body condition at the start of the experiment. The sows had an average parity of 4.7 and parity was balanced across treatments as much as possible. Cross fostering was applied within 3 days after birth within a treatment to standardize the litter size at 12-14 piglets.

From weaning to a couple of days after insemination the sows were housed in individual pens (2.00 m×0.70 m). These pens were equipped with a drinking nipple and feeder and had a partly slatted floor (0.8 m). During gestation, sows were kept in group housing with groups of approximately 150 sows and 4 feeding stations available per group. Sows were transferred from the gestation unit to the farrowing rooms at approximately day 108 of gestation. The farrowing pens (2.25×2.50 m) were equipped with a feeding bin and sows were able to fill the feeder by pushing a metal bar in the feeder. Sows did not have access to straw or other bedding material. Fresh drinking water was freely available ad-libitum during gestation and lactation. The pens had a plastic slatted floor including a heated section for piglets. The temperature schedule was decreasing from 23° C. at farrowing to 20° C. at five days after farrowing. Artificial light was provided from 6:00 till 22:00 hours.

5. Feeding Scheme

During the experiment sows were fed according to the scheme described in Table 4. The piglets were fed ad libitum from day 14 onwards.

TABLE 4
Feeding scheme of the sows during the experimental period

| Period | Day | Diet | Feed allowance (kg/day) |
|---|---|---|---|
| WOI¹ | 1-4 | Lactation | 3.5 |
| | 5-6 | | 2.5 |
| Gestation | 1-39 | Gestation | 2.8 |
| | 40-79 | | 2.6 |
| | 80-108 | | 3.1 |
| | 109-112 | | 3.1 |
| | 113-115 | | 2.5 |
| Lactation | 1 | Lactation | 2.5 |
| | 2 | | 3.0 |
| | 3 | | 3.5 |
| | 4 | | 4.0 |
| | 5 | | 4.5 |
| | 6 | | 5.0 |
| | 7 | | 5.5 |
| | 8 | | 6.0 |
| | 9 | | 6.5 |
| | 10-weaning | | Ad libitum |

¹Weaning to oestrus interval

6. Observations and Recorded Parameters

Several observations to determine sow and piglet performances were done during the experimental period. Sows and piglets were observed daily for abnormalities and clinical signs of illness. Medical treatments were individually registered. An overview of the measurements that were performed and recorded during the experiment are described below and can be found in Appendix 3.

Standard Measurements
Daily feed allowance and feed refusals per individual sow during weaning to oestrus interval (WOI), gestation and lactation;
Body weight and back fat (ultrasonically, P2) at start of the experiment (weaning), day 108 (transfer to farrowing pen) and at weaning (day 26);
Number of total born, live born, stillborn piglets and mummies;
Individual piglet weight at birth, at day 3 after standardisation and weaning;
Piglet mortality during lactation;
Creep feed intake from approximately day 14 to weaning.

Body weight and back fat mobilisation of the sow and growth of the piglets were calculated. Furthermore, the variation in birth weight and weaning weight within a litter was determined.

Additional Measurements
At day 60 of gestation and at day 21 of lactation, blood samples were taken of all the sows to determine the effect of the dietary treatment on the methaemoglobin levels.
At day 60 of gestation and day 1-2 of lactation, faecal samples were taken from all the sows determine the effect of dietary treatment on the total faecal eubacteria, Lactobacilli, E. coli and total C. Perfringens.
On the morning after the farrowing rectal temperature of all the sows was measured to determine an effect on mastitis.

7. Animal Ethics

The experiment was conducted according to the Animal Experimental and Ethics Committee Regulations/Laboratory Practise Codes in the Netherlands (Document AVD 246002015173).

8. Statistical Analysis

Raw data were analysed for outliers and potentially influential outliers were removed with standardized residuals exceeding 2.5 standard deviation units. The results without outliers were subsequently statistically analysed by analysis of variance (ANOVA), using GenStat® for Windows (17^{th} edition). If a significant treatment effect was found, the least significant difference test (LSD) was used for comparing treatment means.

Data was analysed with the following model:

Yᵢⱼ=μ+dietⱼ+eᵢⱼ

Where:

Yᵢⱼ=dependent variable
μ=overall mean
dietⱼ=treatment sow diet (j=T1, T2, T3)
eᵢⱼ=residual error

As a covariate for body weight and back fat development, the body weight and back fat of the sow at start (day of weaning) of the experiment was used. Percentage of dead born piglets, individual piglet weight at birth and coefficient of variance at birth were corrected for number of total born piglets. Pre-weaning litter growth and pre-weaning mortality were corrected for number of live born piglets, and if applicable weaning age.

Differences were considered to be significant when P<0.05 and 0.05≤P<0.10 was considered to be a near-significant trend. Statistics were based on a two-sided test.

Results

To determine the effect of dietary nitrate supplementation in sow diet on sow and piglet performance, 21 sows per treatment started the experiment. However, 15 sows had to be excluded from the experiment mainly due to returning in oestrus (3), abortion (5) and small litter size (3). This resulted in 48 sows that were used for the statistical analysis (Table 5).

TABLE 5
Overview of the distribution and reason of exclusion of sows

| | | Calcium nitrate | |
|---|---|---|---|
| | Control | double salt | L-Arginine |
| Small litter | | 2 | 1 |
| Repeat | 2 | 1 | |
| Abortion | 1 | 2 | 1 |
| No oestrus | | | 2 |
| Others | | 1 | 2 |
| Remaining | 18 | 15 | 15 |

1. Diet Composition and Analysis

Experimental diets were produced in several batches; the lactation diet in 2 batches and the gestation diet in 3 batches. Samples of each dietary batch were analysed by SFR to determine dry matter, ash, crude protein (CP), crude fibre (CF), crude fat (CFat) to verify dietary composition. Analytical results are presented in Table 6. Analysed nutrients were in agreement with calculated composition. The highest variation was in the dry matter content and the rest of the nutrients were in-line with the expected values.

TABLE 6
Calculated and analysed dietary nutrient contents (g/kg) of the experimental diets

| | Lactation diets | | | | | | Gestation diets | | | | | |
|---|---|---|---|---|---|---|---|---|---|---|---|---|
| | A | | B | | C | | D | | E | | F | |
| | Cal | Ana | Cal | Ana | Cal | Ana | Cal | Ana | Cal | Ana | Cal | Ana |
| Ash | 66.2 | 60.6 | 66.3 | 59.6 | 64.8 | 60.2 | 52.9 | 52.9 | 52.9 | 51.5 | 51.5 | 51.9 |
| Dry matter | 878.4 | 896.6 | 878.4 | 896.7 | 878.4 | 896.3 | 882.6 | 895.2 | 882.6 | 895.9 | 882.6 | 896.4 |
| Crude fibre | 65.1 | 61.7 | 65.1 | 61.2 | 64.1 | 61.9 | 102.6 | 103.8 | 102.6 | 105.1 | 102.6 | 105.9 |
| Crude | 141.6 | 148.2 | 141.6 | 150.3 | 144.5 | 149.4 | 111.3 | 119.2 | 111.3 | 120.7 | 114.2 | 120.2 |
| protein | | | | | | | | | | | | |
| Crude fat | 34.6 | 39.8 | 34.6 | 39.9 | 34.6 | 39.6 | 42.8 | 49.7 | 42.8 | 49.2 | 42.8 | 48.4 |
| (ah) | | | | | | | | | | | | |

Furthermore, each batch of the experimental diets were analysed on nitrate level to confirm the inclusion rate of the calcium nitrate double salt (Table 7). Analysed nitrate levels were slightly lower than the intended level. However, the deviation was within range to analyse the effect of dietary nitrate on performance of the sows and piglets.

TABLE 7
Intended and analysed nitrate levels (μg/g) in the experimental diets

| | | | Calcium nitrate | | | |
|---|---|---|---|---|---|---|
| | Control | | double salt | | L-Arginine | |
| | Int | Ana | Int | Ana | Int | Ana |
| Gestation diet | | | | | | |
| Batch 1 | — | 95 | 2000 | 1700 | — | 93 |
| Batch 2 | — | 65 | 2000 | 1930 | — | 79 |
| Batch 3 | — | 130 | 2000 | 2050 | — | 120 |
| Lactation diet | | | | | | |
| batch 1 | — | 20 | 2000 | 1500 | — | 18 |
| batch 2 | — | 16 | 2000 | 1960 | — | 15 |

2. Feed Intake, Body Weight and Back Fat Development

Sows feed intake was calculated by difference in feed allowance and feed refusals during the experimental period. Average feed intake during gestation (day 0 to 108) was 2.7 kg/d and of the lactation diet (day 109 of gestation to weaning) was 5.2 kg/d. At start of the experiment (weaning), sows had an average body weight of 234 kg and a back fat thickness of 16.6 mm. On average the sows gained 44.2 kg body weight and 4.4 mm back fat during gestation and lost 36.6 kg body weight and 4.1 mm back fat during lactation.

In Table 8, the feed intake of the sows for the different experimental treatments is shown. A significant lower feed intake was found during gestation for the sows fed with calcium nitrate double salt compared to the other experimental treatments (P=0.008), resulting in a numerical lower increase in body weight. Although, no effect of dietary treatment on feed intake during lactation was found, a significant lower body weight loss was observed for the sows fed the calcium nitrate double salt (P=0.043) compared to the control diet, with the sows fed on L-arginine showing intermediate results.

TABLE 8
Effect of dietary treatment on feed intake and
body weight (BW) and back-fat (BF) development

| | | Calcium | | | |
|---|---|---|---|---|---|
| | | nitrate | | | |
| | Con- | double | L- | | P- |
| | trol | salt | Arginine | LSD¹ | value |
| Feed intake (kg/d) | | | | | |
| WOI (weaning - | 3.03 | 3.09 | 3.10 | 0.241 | 0.820 |
| insemination) | | | | | |
| Gestation | 2.76^{a} | 2.72^{b} | 2.76^{a} | 0.028 | 0.008 |
| (insemination - | | | | | |
| day 108) | | | | | |
| Lactation (day 109 - | 5.25 | 5.17 | 5.31 | 0.354 | 0.750 |
| weaning) | | | | | |
| Weaning-weaning | 3.39 | 3.35 | 3.39 | 0.095 | 0.567 |
| Body weight | | | | | |
| development | | | | | |
| (kg) ² | | | | | |
| Weaning(start) | 230 | 239 | 235 | 18.2 | 0.627 |
| Day 108 | 281 | 275 | 279 | 6.3 | 0.123 |
| Weaning (end) | 238 | 243 | 242 | 8.2 | 0.355 |
| Weaning - day 108 | 46.9 | 40.6 | 44.5 | 6.27 | 0.123 |
| Day 108 - weaning | −41.8^{a} | −30.8^{b} | −36.1^{ab} | 8.85 | 0.043 |
| Weaning-weaning | 5.1 | 9.8 | 8.4 | 8.18 | 0.467 |
| Back fat development | | | | | |
| (mm) ² | | | | | |
| Weaning (start) | 15.4^{a} | 16.9^{ab} | 17.7^{b} | 1.87 | 0.037 |
| Day 108 | 19.7 | 19.9 | 20.0 | 1.26 | 0.855 |
| Weaning (end) | 15.5 | 15.8 | 16.0 | 1.24 | 0.733 |
| Weaning - day 108 | 3.23 | 3.28 | 3.71 | 1.135 | 0.649 |
| Day 108 - weaning | −4.16 | −4.05 | −4.03 | 1.584 | 0.985 |
| Weaning - weaning | −1.03 | −0.45 | −0.63 | 1.174 | 0.582 |

¹LSD is least significant difference at α < 0.05.
² Body weight and back fat thickness were corrected for body weight and back fat of the sow at start of the experiment (weaning).
^{ab}Different superscripts within one row indicate a significant difference between treatments

3. Sow Performance

On average, sows in the experiment had 17.2 total born piglets and 16.0 live born piglets with an average birth weight of 1281 gram (total born).

In Table 9, the litter size and birth weight of the piglets is shown.

TABLE 9
Effect of dietary treatment on the litter
size and birth weight of the piglets

| | | Calcium | | | |
|---|---|---|---|---|---|
| | | nitrate | | | |
| | | double | L- | | P- |
| | Control | salt | Arginine | LSD¹ | value |
| Litter size (n) | | | | | |
| Total born | 17.8 | 16.7 | 17.1 | 1.78 | 0.470 |
| Live born | 16.4 | 15.3 | 16.1 | 1.63 | 0.346 |
| Still born | 1.3 | 1.3 | 1.0 | 1.11 | 0.809 |
| Mummies | 0.3 | 0.5 | 0.5 | 0.53 | 0.720 |
| % Still born² | 6.7 | 8.5 | 5.8 | 5.64 | 0.631 |
| Birth weight (TB) | | | | | |
| Litter (kg) | 21.9 | 19.6 | 23.0 | 3.04 | 0.078 |
| Individual (g)² | 1274 | 1211 | 1355 | 134.3 | 0.106 |
| Coefficient of | 22.9 | 25.5 | 22.9 | 3.89 | 0.324 |
| variation (%)² | | | | | |

¹LSD is least significant difference at α < 0.05.
²Corrected for the number of total born piglets.

4. Piglet Performance

In this experiment the piglets had an average weaning weight of 7.6 kg, which means an average growth of 234 g/d from birth till weaning. Furthermore, the average pre-weaning piglet mortality was 7.1%.

In Table 10, the effect of the different dietary treatments on piglet performance is shown.

TABLE 10
Effect of dietary treatment on piglet performance pre-weaning

| | | Calcium | | | |
|---|---|---|---|---|---|
| | | nitrate | | | |
| | | double | L- | | P- |
| | Control | salt | Arginine | LSD¹ | value |
| Number of piglets | | | | | |
| Start (after | 13.2 | 13.1 | 13.2 | 0.64 | 0.908 |
| standardization) | | | | | |
| Weaning | 12.4 | 12.0 | 12.1 | 0.96 | 0.574 |
| Litter (kg) | | | | | |
| Weaning weight | 96.9 | 91.7 | 91.2 | 10.90 | 0.498 |
| Growth ² | 79.6 | 75.5 | 73.8 | 9.36 | 0.425 |
| Piglet weight (kg) | | | | | |
| Weaning weight ² | 7.74 | 7.60 | 7.52 | 0.580 | 0.742 |
| Coefficient of | 15.4 | 15.4 | 15.9 | 2.81 | 0.646 |
| variation | | | | | |
| (%) ² | | | | | |
| Growth ² | 6.35 | 6.27 | 6.08 | 0.563 | 0.604 |
| Mortality (%) | | | | | |
| Start - weaning ² | 5.4 | 8.0 | 8.4 | 6.86 | 0.621 |
| Creep feed (g) | | | | | |
| Piglet/d | 11.5 | 13.9 | 12.8 | 7.49 | 0.808 |

¹LSD is least significant difference at α < 0.05
² Corrected for the number of piglets after standardisation and weaning age.

5. Intestinal Health

The effect of dietary treatment on intestinal health was analysed by determining the number of Total eubacteria, Lactobacilli, E. coli and Cl. Perfringens in the faeces during gestation and a couple of days after farrowing. As observed in Table 11, no effect of dietary treatment on faecal bacteria counts was found. However, Cl. Perfringens counts seemed to be lower for the sows supplemented with calcium nitrate double salt in both the gestation period and the lactation period.

TABLE 11
Effect of dietary treatment on faecal bacteria counts (cfu log₁₀)

| | | Calcium | | | |
|---|---|---|---|---|---|
| | | nitrate | | | |
| | | double | L- | | P- |
| | Control | salt | Arginine | LSD ¹ | value |
| Day 60 of gestation | | | | | |
| Total eubacteria | 12.3 | 12.3 | 12.3 | 0.09 | 0.597 |
| Lactobacilli | 10.8 | 10.8 | 11.0 | 0.27 | 0.436 |
| E. coli | 8.4 | 8.4 | 8.4 | 0.49 | 0.963 |
| Cl. Perfringens | 9.0 | 8.6 | 8.7 | 0.27 | 0.147 |
| After farrowing | | | | | |
| Total eubacteria | 12.3 | 12.5 | 12.4 | 0.20 | 0.127 |
| Lactobacilli | 10.9 | 10.9 | 10.8 | 0.54 | 0.868 |
| E. coli | 9.3 | 9.6 | 9.5 | 0.53 | 0.480 |
| Cl. Perfringens | 9.0 | 8.5 | 9.0 | 0.61 | 0.227 |

¹ LSD is least significant difference at α < 0.05

Furthermore, no effect of dietary treatment on rectal temperature of the sow as an indication of mastitis was found (Table 12).

TABLE 12
Effect of dietary treatment on rectal temperature
of the sows the morning after farrowing

| | | Calcium | | | |
|---|---|---|---|---|---|
| | | nitrate | | | |
| | | double | L- | | P- |
| | Control | salt | Arginine | LSD¹ | value |
| Rectal temperature (° C.) | 38.9 | 39.0 | 38.9 | 0.378 | 0.952 |

¹LSD is least significant difference at α < 0.05

6. Blood Parameters

As in experiment 1, blood samples were also taken in experiment 2 to determine the effect of calcium nitrate double salt on blood methaemoglobin. As shown in Table 13, at day 60 of gestation sows that were fed with the L-arginine diet showed a significant lower methaemoglobin level compared to the other dietary treatments (P=0.001), resulting in a significant lower ratio methaemoglobin/haemoglobin (P=0.002). The sows fed the calcium nitrate double salt only had a numerical increased methaemoglobin level at day 60 of gestation compared to the sows fed the control diet. No effect of dietary treatments on blood levels at day 21 of lactation were found.

TABLE 13
Effect of dietary treatment on blood parameters
(haemoglobin (Hb), methaemoglobin (Met Hb) and
ratio methaemoglobin/haemoglobin (Met Hb/Hb)

| | | Calcium | | | |
|---|---|---|---|---|---|
| | | nitrate | | | |
| | | double | L- | | P- |
| | Control | salt | Arginine | LSD ¹ | value |
| Day 60 of gestation | | | | | |
| Hb (g/dL) | 13.0 | 13.0 | 12.9 | 1.09 | 0.986 |
| Met Hb (g/dL) | 2.4^{a} | 2.9^{a} | 1.6^{b} | 0.62 | 0.001 |
| Met Hb/Hb (%) | 18.8^{a} | 22.7^{a} | 12.9^{b} | 5.33 | 0.002 |
| Day 21 of lactation | | | | | |
| Hb (g/dL) | 12.5 | 12.7 | 12.5 | 1.11 | 0.939 |
| Met Hb (g/dL) | 2.2 | 1.6 | 2.0 | 0.75 | 0.264 |
| Met Hb/Hb (%) | 16.1 | 13.4 | 15.9 | 5.25 | 0.504 |

¹ LSD is least significant difference at α < 0.05
^{ab}Different superscripts within one row indicate a significant difference between treatments

### CONCLUSION

The objective of this project was to evaluate the effect of calcium nitrate double salt, supplemented to sows from weaning to weaning on sows and piglets performance. Initial hypothesis of supplementing gestation and lactation diet with calcium nitrate double salt was that it would have a similar effect on results productive as L-arginine due to a similar mode of action. Arginine is known to affect the development of the placenta and mammary gland by stimulating the development of the blood vessels, which would improve blood supply and therefore nutrient supply to the fetus and amino acid uptake of the mammary gland. An improved nutrient supply to the fetus can result in an increase in litter size and piglet weight and therefore litter size.

Since the dietary nitrate will partly be converted into nitrite in the body of the sow, the concern of whether the supplementation of calcium nitrate double salt to the diet could increase in methaemoglobin/haemoglobin ratio in the blood of the sow resulting in oxygen shortage in the blood was evaluated. However, as the results showed the methaemoglobin/haemoglobin ratios were only slightly increased at day 7 but recovered before day 14 of the experiment. In conclusion, the sows were able to adjust to the increase in nitrate due to a supplementation of calcium nitrate double salt to the diet. Thus no negative affect was detected to the health of the sows.

The supplementation of calcium nitrate double salt did result in a slightly lower feed intake during gestation, which could explain the difference in litter and piglet weight at birth between the group fed L-arginine supplemented diet compared to the CAN-fed group. However, no further difference was detected in the litter weight before weaning between the sows fed a diet supplemented with L-arginine and calcium nitrate double salt.

The supplementation of calcium nitrate double salt to the sow diets did result in a significant lower body weight loss of the sows during lactation, which can have a beneficial effect on reproductive performance of the sows in the next cycle (Hoving et al., Dom Anim 47, 1009-1016 (2012) due to a better follicle development during the last weeks of lactation.

Besides the effect on the placenta and the mammary gland, supplementation of nitrate to the gestating and lactation sow diets was expected to indirectly positively affect intestinal health and therefore reduce the excretion of pathogenic bacteria in the faeces. It was found that calcium nitrate double salt supplementation on bacteria counts in the faeces resulted in a numerically lower Cl. Perfringens counts, both during gestation and lactation period, which could benefit the health of the sows and piglets.

No essential difference in response to supplementation of L-arginine and calcium nitrate double salt were found in this experiment, thus a similar mode of action of calcium nitrate double salt as L-arginine cannot be denied.

Appendix 1. Composition of the experimental diets for experiment 1

TABLE 1
Composition (%) and calculated nutrient levels (g/kg) of the experimental diets for experiment 1

| | | A | B | C |
|---|---|---|---|---|
| | | 0.31% Calcium | 0.63% Calcium | 1.25% Calcium |
| | | nitrate double salt | nitrate double salt | nitrate double salt |
| Barley | | 15.00 | 15.00 | 15.00 |
| Maize | | 20.00 | 20.00 | 20.00 |
| Molass cane >47.5% Su | | 4.00 | 4.00 | 4.00 |
| Palm kernel meal. <20 CF | | 5.00 | 5.00 | 5.00 |
| Sugar beet pulp 20-25% | | 2.50 | 2.50 | 2.50 |
| Soybean meal 47% CP | | 2.86 | 2.86 | 2.86 |
| Wheat | | 22.07 | 22.07 | 22.07 |
| Wheat middlings | | 13.39 | 13.39 | 13.39 |
| Monocalcium phosphate | | 0.68 | 0.68 | 0.68 |
| Salt | | 0.24 | 0.24 | 0.24 |
| Sunflower hulls 38% CP | | 10.00 | 10.00 | 10.00 |
| Lysine-HCl (L 79%) | | 0.35 | 0.35 | 0.35 |
| Metheonine (DL 99%) | | 0.01 | 0.01 | 0.01 |
| Threonine (L 98%) | | 0.13 | 0.13 | 0.13 |
| Lys + trypt premix18/5 | | 0.19 | 0.19 | 0.19 |
| Min/Vit Sow | | 0.50 | 0.50 | 0.50 |
| Sodium bicarbonate | | 0.31 | 0.31 | 0.31 |
| Fytase premix | | 0.33 | 0.33 | 0.33 |
| Calcium nitrate double salt | | 1.68 | 1.51 | 1.20 |
| Limestone | | 0.31 | 0.63 | 1.25 |
| Diamol | | 0.46 | 0.30 | — |
| Nutrients | | | | |
| g/Kg | Moisture | 128.22 | 128.22 | 128.22 |
| g/Kg | Ash | 65.93 | 66.07 | 66.32 |
| g/Kg | Crude Protein | 141.26 | 141.26 | 141.26 |
| g/Kg | Crude fat | 24.63 | 24.63 | 24.63 |
| g/Kg | Crude fibre | 53.93 | 53.93 | 53.93 |
| g/Kg | Starch | 378.48 | 378.48 | 378.48 |
| g/Kg | Sugar | 53.01 | 53.01 | 53.01 |
| MJ/kg | NE_Swine | 8.77 | 8.77 | 8.77 |
| g/Kg | Ca | 9.30 | 9.30 | 9.30 |
| g/Kg | P | 6.07 | 6.07 | 6.07 |
| g/Kg | Na | 2.00 | 2.00 | 2.00 |
| g/Kg | Cl | 3.59 | 3.59 | 3.59 |
| g/Kg | K | 8.29 | 8.29 | 8.29 |
| g/Kg | Cu | 8.69 | 8.65 | 8.57 |
| g/Kg | Zn | 38.27 | 38.22 | 38.13 |
| g/Kg | dEB | 200.33 | 200.22 | 200.00 |
| g/Kg | avCav | 10.04 | 10.22 | 10.56 |
| g/Kg | dP intns | 3.20 | 3.20 | 3.20 |
| g/Kg | FCHO | 140.19 | 140.19 | 140.19 |
| g/Kg | ICHO | 95.53 | 95.53 | 95.53 |
| g/Kg | NSP | 216.96 | 216.96 | 216.96 |
| g/Kg | SID_LYSs | 7.14 | 7.14 | 7.14 |
| g/Kg | SID_METs | 2.20 | 2.20 | 2.20 |
| g/Kg | SID_M + Cs | 4.32 | 4.32 | 4.32 |
| g/Kg | SID_THRs | 5.01 | 5.01 | 5.01 |
| g/Kg | SID_TRPs | 1.41 | 1.41 | 1.41 |
| g/Kg | SID_ARGs | 7.84 | 7.84 | 7.84 |
| | SID met/SID lys | 0.31 | 0.31 | 0.31 |
| | SID m + c/SID lys | 0.60 | 0.60 | 0.60 |
| Nutrients | | A | B | C |
| | SID threo/SID lys | 0.70 | 0.70 | 0.70 |
| | SID tryp/SID lys | 0.20 | 0.20 | 0.20 |
| | SID arg/SID lys | 1.10 | 1.10 | 1.10 |
| | C16 + 18.0/Fat | 0.16 | 0.16 | 0.16 |
| g/Kg | C16 + 18:0 | 3.88 | 3.88 | 3.88 |
| g/Kg | C16 + 18 > 0 | 16.51 | 16.51 | 16.51 |
| | C16 + 18 > 0/C16 + 18. | 4.25 | 4.25 | 4.25 |
| g/Kg | C18:2 | 11.26 | 11.26 | 11.26 |
| g/Kg | C18:2 + 3 | 11.94 | 11.94 | 11.94 |

Appendix 2. Composition of the experimental diets for experiment 2

TABLE 1
Composition (%) and calculated nutrient levels (g/kg)
of the experimental diets for experiment 2

| | Lactation diet | | | Gestation diet | | |
|---|---|---|---|---|---|---|
| | | B | | | E | |
| | | Calcium | | | Calcium | |
| | | nitrate | C | | nitrate | F |
| | A | double | L- | D | double | L- |
| | Control | salt | Arginine | Control | salt | Arginine |
| Barley | 15.00 | 15.00 | 15.00 | 15.00 | 15.00 | 15.00 |
| Maize | 20.00 | 20.00 | 20.00 | 10.00 | 10.00 | 10.00 |
| Molass. cane >47.5% Su | 4.00 | 4.00 | 4.00 | 4.00 | 4.00 | 4.00 |
| Palm kernel meal. <20 CF | 5.00 | 5.00 | 5.00 | 5.00 | 5.00 | 5.00 |
| Sugar beet pulp 20-25% | 2.50 | 2.50 | 2.50 | 6.56 | 6.56 | 6.56 |
| Soybean meal 47% CP | 2.86 | 2.86 | 2.86 | | | |
| Wheat | 22.07 | 22.07 | 22.07 | 17.3 | 17.3 | 17.3 |
| Wheat middlings | 13.39 | 13.39 | 13.39 | 15.00 | 15.00 | 15.00 |
| Mono calciumphosphate | 0.68 | 0.68 | 0.68 | 0.20 | 0.20 | 0.20 |
| Salt | 0.24 | 0.24 | 0.24 | | | |
| Animal fat <0.5% PFA | | | | 1.01 | 1.01 | 1.01 |
| Soybean hulls >36% CF | | | | 10.00 | 10.00 | 10.00 |
| Sunflower hulls 38% CP | 10.00 | 10.00 | 10.00 | 2.89 | 2.89 | 2.89 |
| Lysine-HCl (L 79%) | 0.35 | 0.35 | 0.35 | 0.18 | 0.18 | 0.18 |
| Metheonine (DL 99%) | 0.01 | 0.01 | 0.01 | | | |
| Threonine (L 98%) | 0.13 | 0.13 | 0.13 | 0.06 | 0.06 | 0.06 |
| Lys + trypt premix 18/5 | 0.19 | 0.19 | 0.19 | | | |
| Sugar beet pulp 20-25 | | | | 10.00 | 10.00 | 10.00 |
| Min/Vit Sow | 0.50 | 0.50 | 0.50 | 0.50 | 0.50 | 0.50 |
| Sodium bicarbonate | 0.31 | 0.31 | 0.31 | 0.44 | 0.44 | 0.44 |
| Limestone | 1.84 | 1.68 | 1.84 | 0.88 | 0.73 | 0.88 |
| Palm oil (coater) | | | | 0.50 | 0.50 | 0.50 |
| Fytase premix | 0.33 | 0.33 | 0.33 | 0.33 | 0.33 | 0.33 |
| Calcium nitrate double salt | | 0.31 | | | 0.30 | |
| Arginine (L 99%) | | | 0.15 | | | 0.15 |
| Diamol | 0.61 | 0.46 | 0.46 | 0.15 | | |

| Nutrients | | | | | | | |
|---|---|---|---|---|---|---|---|
| g/Kg | Moisture | 128.22 | 128.22 | 128.21 | 122.71 | 122.72 | 122.70 |
| g/Kg | Ash | 65.81 | 65.93 | 64.45 | 53.48 | 53.60 | 52.17 |
| g/Kg | Crude Protein | 141.26 | 141.26 | 144.28 | 111.64 | 111.64 | 114.55 |
| g/Kg | Crude fat | 24.63 | 24.63 | 24.63 | 36.57 | 36.57 | 36.57 |
| g/Kg | Crude fibre | 53.93 | 53.93 | 53.93 | 95.69 | 95.69 | 95.69 |
| g/Kg | Starch | 378.48 | 378.48 | 378.48 | 288.67 | 288.67 | 288.67 |
| g/Kg | Sugar | 53.01 | 53.01 | 53.01 | 76.45 | 76.45 | 76.45 |
| MJ/kg | NE_Swine | 8.77 | 8.77 | 8.79 | 8.52 | 8.52 | 8.53 |
| g/Kg | Ca | 9.30 | 9.30 | 9.30 | 6.20 | 6.20 | 6.20 |
| g/Kg | P | 6.07 | 6.07 | 6.07 | 3.97 | 3.97 | 3.97 |
| g/Kg | Na | 2.01 | 2.00 | 2.01 | 1.74 | 1.74 | 1.74 |
| g/Kg | Cl | 3.59 | 3.59 | 3.59 | 1.71 | 1.71 | 1.71 |
| g/Kg | K | 8.29 | 8.29 | 8.29 | 9.84 | 9.83 | 9.84 |
| g/Kg | Cu | 8.73 | 8.69 | 8.73 | 7.02 | 6.98 | 7.02 |
| g/Kg | Zn | 38.32 | 38.27 | 38.32 | 36.93 | 36.88 | 36.93 |
| g/Kg | dEB | 200.4 | 200.3 | 200.4 | 280.11 | 280 | 280.11 |
| g/Kg | avCav | 9.87 | 10.04 | 9.87 | 6.77 | 6.93 | 6.77 |
| g/Kg | dP mild | 3.51 | 3.51 | 3.51 | 2.40 | 2.40 | 2.40 |
| g/Kg | dP intns | 3.20 | 3.20 | 3.20 | 2.11 | 2.11 | 2.11 |
| g/Kg | FCHO | 140.19 | 140.19 | 140.19 | 225.00 | 225.00 | 225.00 |
| g/Kg | ICHO | 95.53 | 95.53 | 95.53 | 108.43 | 108.43 | 108.43 |

| | | Gestation diet | | | Lactation diet | | |
|---|---|---|---|---|---|---|---|
| | | T1 | T2 | T3 | T1 | T2 | T3 |
| g/Kg | NSP | 216.96 | 216.96 | 216.96 | 317.11 | 317.11 | 317.11 |
| g/Kg | SID_LYSs | 7.14 | 7.14 | 7.14 | 4.35 | 4.35 | 4.35 |
| g/Kg | SID_METs | 2.20 | 2.20 | 2.20 | 1.50 | 1.50 | 1.50 |
| g/Kg | SID_M + Cs | 4.32 | 4.32 | 4.32 | 3.06 | 3.06 | 3.06 |
| g/Kg | SID_THRs | 5.01 | 5.01 | 5.01 | 3.14 | 3.14 | 3.14 |
| g/Kg | SID_TRPs | 1.41 | 1.41 | 1.41 | 0.92 | 0.92 | 0.92 |
| g/Kg | SID_ARGs | 7.84 | 7.84 | 9.32 | 5.2 | 5.2 | 6.63 |
| | SID met/SID lys | 0.31 | 0.31 | 0.31 | 0.34 | 0.34 | 0.34 |
| | SID m + c/SID lys | 0.60 | 0.60 | 0.60 | 0.70 | 0.70 | 0.70 |
| | SID threo/SID lys | 0.70 | 0.70 | 0.70 | 0.72 | 0.72 | 0.72 |
| | SID tryp/SID lys | 0.20 | 0.20 | 0.20 | 0.21 | 0.21 | 0.21 |
| | SID arg/SID lys | 1.10 | 1.10 | 1.30 | 1.19 | 1.19 | 1.52 |
| | C16 + 18.0/Fat | 0.16 | 0.16 | 0.16 | 0.25 | 0.25 | 0.25 |
| g/Kg | C16 + 18:0 | 3.88 | 3.88 | 3.88 | 8.99 | 8.99 | 8.99 |
| g/Kg | C16 + 18 > 0 | 16.51 | 16.51 | 16.51 | 20.52 | 20.52 | 20.52 |
| | C16 + 18 > 0/C16 + 18.0 | 4.25 | 4.25 | 4.25 | 2.28 | 2.28 | 2.28 |
| g/Kg | C18:2 | 11.26 | 11.26 | 11.26 | 10.37 | 10.37 | 10.37 |
| g/Kg | C18:2 + 3 | 11.94 | 11.94 | 11.94 | 11.19 | 11.19 | 11.19 |

1-24. (canceled)

25. An animal feed supplement comprising 10 to 100 weight % of an inorganic nitrate compound, for use in the treatment of a gestating monogastric mammal for improving reproductive performance or in the treatment of a lactating and/or gestating monogastric mammal for lowering the risk of PDS (Post-parturient Dysgalactia Syndrome).

26. The animal feed supplement for use according to claim 25, wherein the inorganic nitrate compound is selected from the group of sodium nitrate, potassium nitrate, calcium nitrate, ammonium nitrate, or any combination thereof, most preferably the compound, represented by the formula 5Ca(NO₃)₂.NH₄NO₃-10H₂O.

27. The animal feed supplement for use according to claim 25, wherein the inorganic nitrate compound is available in the form of a powder, a compacted powder, a crystal, a prill, a granule, a liquid, a gel, a solution, a liquid, or a flake.

28. The animal feed supplement for use according to claim 25, further comprising 1 to 50 weight % of L-arginine.

29. Compounded animal feed comprising animal feed supplement comprising 10 to 100 weight % of an inorganic nitrate compound, providing a total amount of nitrate in excess of 0.1 g/kg, on a dry weight basis, for use in the treatment of a gestating and/or lactating monogastric mammal for improving reproductive performance or in the treatment of a gestating and/or lactating monogastric mammal for lowering the risk of PDS (Post-parturient Dysgalactia Syndrome).

30. Inorganic nitrate for use in the treatment of a monogastric mammal for improving the reproductive performance, wherein the inorganic nitrate compound being a feed additive.

31. The inorganic nitrate for use according to claim 30, wherein the inorganic nitrate is selected from the group of sodium nitrate, potassium nitrate, calcium nitrate, ammonium nitrate, or any combination thereof, most preferably the compound, represented by the formula 5Ca(NO₃)₂.NH₄NO₃-10H₂O.

32. The inorganic nitrate for use according to claim 30, wherein the inorganic nitrate is given in a daily dosage of nitrate in excess of 1 mg/kg body weight, preferably within the range of 1 to 320 mg/kg body weight.

33. The inorganic nitrate for use according to claim 30, wherein the inorganic nitrate is given during the lactation and/or gestation period.

34. Feed, suitable for a female monogastric mammal in lactation and/or gestation phase, comprising:
50-200 g/kg, preferably 100-150 g/kg of crude protein,
10-100 g/kg, preferable 10-50 g/kg of crude fat,
25-200 g/kg, preferably 50-100 g/kg of crude fiber,
150-600 g/kg, preferably 200-400 g/kg of starch,
25-200 g/kg, preferably 50-100 g/kg of sugar, and
0.1-5 weight %, preferably 0.2-2 weight % of calcium ammonium nitrate, most preferably the compound, represented by the formula 5Ca(NO₃)₂—NH₄NO₃.10H₂O for improving reproductive performance of a female monogastric mammal.

35. The feed for use according to claim 34, wherein the feed in addition comprises 1.25-10 weight % of arginine.
